(19) United States
(12) Patent Application Publication
(10) Pub. No.: US 2009/0327310 A1
(43) Pub. Date: Dec. 31, 2009

(54) METHODS FOR PROVIDING ACCESS TO FILES ON AN ELECTRONIC DEVICE USING A PHONE NUMBER FOR AUTHENTICATION AND RELATED ELECTRONIC DEVICES AND COMPUTER PROGRAM PRODUCTS

(75) Inventors: Henrik Sven Bengtsson, Lund (SE); Ola Montan, Akarp (SE); Tobias Jan Robert Ritzau, Veberod (SE); Troed Sangberg, Malmo (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/412,209

(22) Filed: Mar. 26, 2009

Related U.S. Application Data
(60) Provisional application No. 61/076,379, filed on Jun. 27, 2008.

(51) Int. Cl. G06F 17/30; G06F 15/16

(52) U.S. Cl. 707/10; 709/227; 707/E17.01; 707/E17.032; 709/206

(57) ABSTRACT

A method of operating a first electronic device to access files on a second electronic device includes registering with a proxy server to obtain a communication session identification, sending a request to the second electronic device to access files thereon, the request comprising the communication session identification and a phone number associated with the first electronic device, and receiving a notification from the proxy server that a connection has been established with the second electronic device responsive to the second electronic device accepting the request.

### CROSS REFERENCE TO RELATED APPLICATION

This application claims the benefit of and priority to U.S. Provisional Patent Application No. 61/076,379, filed Jun. 27, 2008, the disclosure of which is hereby incorporated herein by reference as if set forth in its entirety.

### BACKGROUND OF THE INVENTION

The present invention relates to communication networks, and, more particularly, to methods, electronic devices, and computer program products for providing access to files on an electronic device.

A user of a mobile terminal may have files, such as pictures, documents, and the like stored thereon that the user would like to share with other people. Access may be provided to such files by putting a Web server on the mobile terminal. This, however, may mean that anyone can access the files on the mobile terminal. In addition, if the mobile terminal has a private Internet Protocol (IP) address, then the mobile terminal may not be addressable on the Internet. In this case, the mobile terminal may register on a server with a public IP address. But to be publicly available, the mobile terminal needs to be connected to the server. Expenses may be incurred based on the amount of time that the mobile terminal is connected to the server. The battery on the mobile terminal may also be drained while connected to the server even when other parties are not accessing the files thereon.

### SUMMARY

In some embodiments of the present invention, a method of operating a first electronic device to access files on a second electronic device comprises registering with a proxy server to obtain a communication session identification, sending a request to the second electronic device to access files thereon, the request comprising the communication session identification and a phone number associated with the first electronic device, and receiving a notification from the proxy server that a connection has been established with the second electronic device responsive to the second electronic device accepting the request.

In other embodiments, the method further comprises establishing an HTTP communication session with the second electronic device via the proxy server.

In still other embodiments, the method further comprises displaying information for contacting the second electronic device and receiving input from a user indicative of a desire to contact the second electronic device, wherein registering with the proxy server comprises registering with the proxy server responsive to the input from the user indicative of the desire to contact the second electronic device.

In still other embodiments, sending the request to the second electronic device comprises sending the request to the second electronic device using Short Message Service (SMS).

In still other embodiments, the method further comprises associating a third electronic device with the first electronic device by sending a phone number associated with the first electronic device to the proxy server using the third electronic device, receiving a code from the proxy server at the first electronic device, sending the code received from the proxy server back to the proxy server using the first electronic device, and establishing a communication session between the third electronic device and the second electronic device via the proxy server.

In still other embodiments, the first and second electronic devices are mobile terminals.

In further embodiments of the present invention, a method of operating a first electronic device to provide a second electronic device access to files stored thereon, comprises receiving a request from the second electronic device to access files stored on the first electronic device, the request comprising a communication session identification and a phone number associated with the second electronic device and establishing a connection with a proxy server using the session identification.

In still further embodiments, the method further comprises establishing an HTTP communication session with the second electronic device via the proxy server.

In still further embodiments, the method further comprises launching a Web server module responsive to receiving the request.

In still further embodiments, the method further comprises downloading a Web server module responsive to receiving the request.

In still further embodiments, the method further comprises sending a message to the second electronic device responsive to receiving the request to verify the phone number associated with the second electronic device.

In still further embodiments, the method further comprises displaying a prompt indicating that the second electronic device has requested access to the files stored on the first electronic device and receiving input from a user granting the request to access the files stored on the first electronic device, wherein establishing the connection with the proxy server comprises establishing the connection with the proxy server responsive to receiving input from the user granting the request.

In still further embodiments, the received request is a Short Message Service (SMS) message.

In still further embodiments, the accessibility of the files on the first electronic device is based on requester identity.

In still further embodiments, the first electronic device comprises at least one list that categorizes requesters based on file accessibility.

In still further embodiments, the first and second electronic devices are mobile terminals.

In still other embodiments, a computer program product comprises computer-readable program code embodied on a computer-readable medium, the computer readable program code being configured to carry out one or more of the above-described methods.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a client-server environment in accordance with some embodiments of the present invention;

FIG. 2 is a block diagram that illustrates a communication network in accordance with some embodiments of the present invention;

FIG. 3 is a block diagram that illustrates an electronic device/mobile terminal in accordance with some embodiments of the present invention; and

FIGS. 4 and 5 are message flow diagrams that illustrate operations for providing access to files on an electronic device/mobile terminal using a phone number for authentication in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: a portable computer diskette, a random access memory (RAM), a read-only memory (ROM), an erasable programmable read-only memory (EPROM or Flash memory), and a compact disc read-only memory (CD-ROM).

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

As used herein, the term “file” may include any construct that binds a conglomeration of information, such as instructions, numbers, words, and/or images into a coherent unit. Accordingly, a file may be, for example, a document, an image, an email, a database document, an application, and/or a Web page.

For purposes of illustration, embodiments of the present invention are described herein in the context of a mobile terminal. It will be understood, however, that the present invention is not limited to such embodiments and may be embodied generally as an electronic device that is capable of communication over a network, such as the Internet, and using one or more communication protocols, such as the TCP/IP and/or Short Messaging Service (SMS) protocols.

According to some embodiments of the present invention, a user of an electronic device/mobile terminal may provide others with access to files thereon by using the phone number of a person seeking access to the files as a means of authentication.

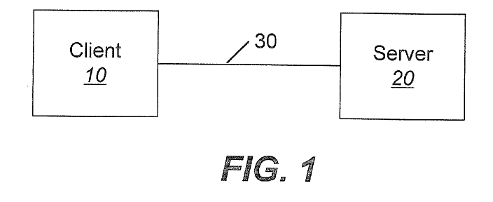

Embodiments according to the invention can operate in a logically separated client side/server side-computing environment, sometimes referred to hereinafter as a client/server environment. As shown in FIG. 1, a client 10 may communicate with a server 20 over a wireless and/or wireline communication medium 30. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a Web browser, that requests information, such as web pages, from a server under the control of a user. Examples of clients include browsers such as Netscape Navigator® (America Online, Inc., Dulles, Va.) and Internet Explorer® (Microsoft Corporation, Redmond, Wash.). Browsers typically provide a graphical user interface for retrieving and viewing web pages, web portals, applications, and other resources served by Web servers. A SOAP client can be used to request web services programmatically by a program in lieu of a web browser. The applications provided by the service providers may execute on a server. The server can be a program that responds to the requests from the client. Some examples of servers are International Business Machines Corporation's family of Lotus Domino® servers, the Apache server and Microsoft's Internet Information Server (IIS) (Microsoft Corporation, Redmond, Wash.).

The clients and servers can communicate using a standard communications mode, such as Hypertext Transport Protocol (HTTP) and SOAP. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

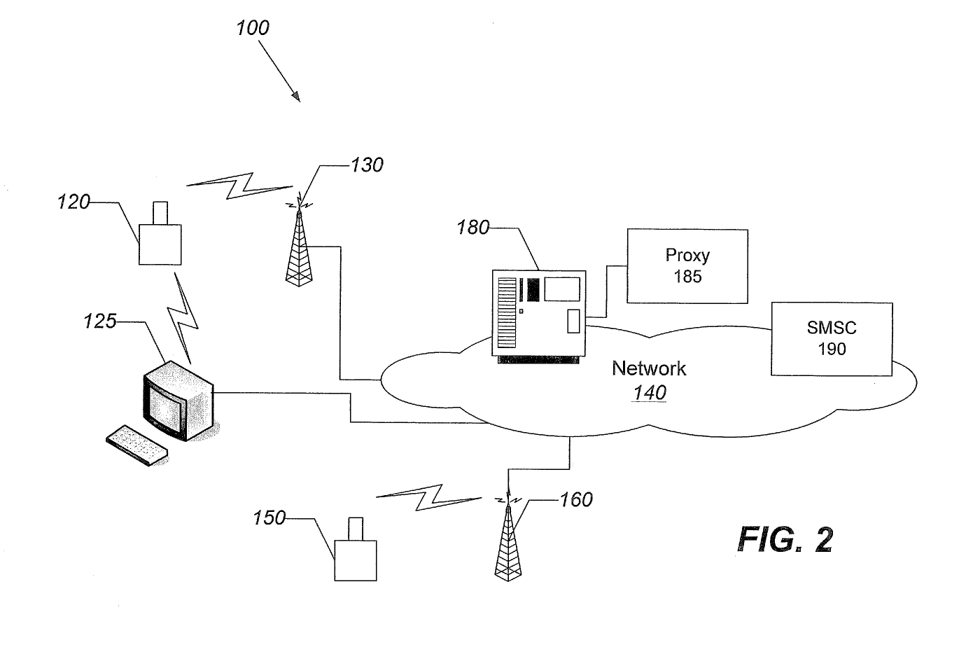

Referring now to FIG. 2, a network architecture, according to some embodiments of the present invention, includes a mobile terminal 120 that includes a Web Access/Web Server application thereon, a computer 125 that is associated with the user of the mobile terminal 120, a mobile terminal 150 that includes a Web Access/Web Server application thereon, a Proxy server 180, and a Short Message Service Center (SMSC) 190 that are connected via a network 140 as shown. The network 140 includes wireless base station transceivers 130 and 160 that may facilitate wireless communication with the mobile terminals 120 and 150, respectively. The Proxy server 180 may include a Proxy module 185 that is configured to facilitate setting up of TCP/IP communication sessions between mobile terminal 120 and mobile terminal 150 and to act as a proxy for file access requests and responses between mobile terminal 120 and mobile terminal 150. The SMSC 190 may facilitate communication between devices, such as mobile terminals 120 and 150, using the Short Message Peer-to-Peer protocol (SMPP) to receive and deliver Short Message Service (SMS) messages. The network 140 may represent a global network, such as the Internet, or other publicly accessible network. The network 140 may also, however, represent a wide area network, a local area network, an Intranet, or other private network, which may not accessible by the general public. Furthermore, the network 140 may represent a combination of public and private networks or a virtual private network (VPN). Moreover, devices 120 and 150 are described as mobile terminals for purposes of illustrating some embodiments of the present invention. It will be understood that each of the devices 120 and 150 may be any electronic device that is capable of communicating via a network using, for example, a communication protocol, such as TCP/IP and/or SMS.

Although FIG. 2 illustrates an exemplary communication network, it will be understood that the present invention is not limited to such configurations, but is intended to encompass any configuration capable of carrying out the operations described herein.

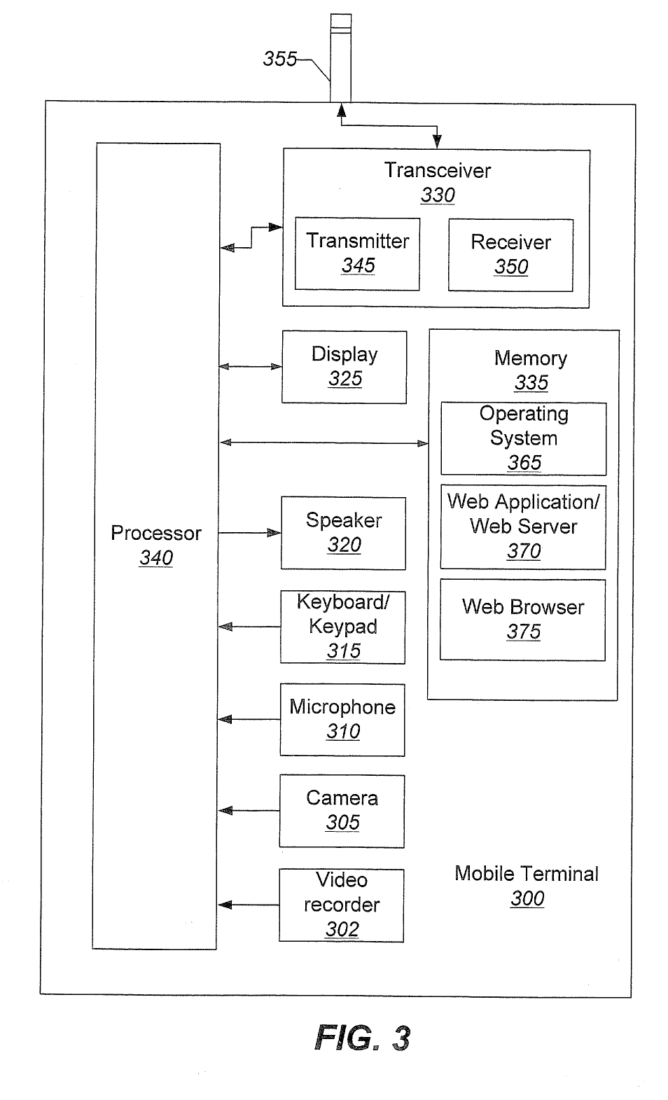

Referring now to FIG. 3, an exemplary mobile terminal 300 that may be used to implement mobile terminal 120 and/or 150 of FIG. 2, in accordance with some embodiments of the present invention, includes a video recorder 302, a camera 305, a microphone 310, a keyboard/keypad 315, a speaker 320, a display 325, a transceiver 330, and a memory 335 that communicate with a processor 340. The transceiver 330 comprises a transmitter circuit 345 and a receiver circuit 350, which respectively transmit outgoing radio frequency signals to base station transceivers and receive incoming radio frequency signals from the base station transceivers via an antenna 355. The radio frequency signals transmitted between the mobile terminal 300 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 300 may be included in many conventional mobile terminals and their functionality is generally known to those skilled in the art.

The processor 340 communicates with the memory 335 via an address/data bus. The processor 340 may be, for example, a commercially available or custom microprocessor. The memory 335 is representative of the one or more memory devices containing the software and data used to provide a phone-based Web server with a private IP address, in accordance with some embodiments of the present invention. The memory 335 may include, but is not limited to, the following types of devices: cache, ROM, PROM, EPROM, EEPROM, flash, SRAM, and DRAM.

As shown in FIG. 3, the memory 335 may contain up to three or more categories of software and/or data: the operating system 365, a Web Application/Web Server module 370, and a Web browser module 375. The operating system 365 generally controls the operation of the mobile terminal 300. In particular, the operating system 365 may manage the mobile terminal's software and/or hardware resources and may coordinate execution of programs by the processor 340. The Web Application/Web Server module 370 may be configured to facilitate setting up TCP/IP communication sessions and may also provide a Web server function. It will be understood that the particular functionality provided by the Web Application/Web Server module 370 may be based on the particular role associated with the mobile terminal on which it resides. For example, if the mobile terminal is not being used as a Web server to provide access to files thereon to others, then the Web Server functionality may not be included. The Web browser module 375 may be configured to provide a user of the mobile terminal with access to various media typically displayed via a Web page and accessible via, for example, a public network, such as the World Wide Web (WWW), a local network, a private network, or any combination of the foregoing types of networks.

Although FIG. 3 illustrates an exemplary software and hardware architecture that may be used to provide a mobile terminal that can provide others with access to files thereon by using the phone number of a person seeking access to the files as a means of authentication, it will be understood that the present invention is not limited to such a configuration, but is intended to encompass any configuration capable of carrying out the operations described herein.

Computer program code for carrying out operations of devices and/or systems discussed above with respect to FIGS. 1-3 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to message flow diagram illustrations of methods, mobile terminals, electronic devices, Internet servers, and/or computer program products in accordance with some embodiments of the invention.

These message flow diagrams further illustrate exemplary operations of providing a mobile terminal that can provide others with access to files thereon by using the phone number of a person seeking access to the files as a means of authentication in accordance with some embodiments of the present invention. It will be understood that each message, and combinations of messages in the message flow diagram illustrations, may be generated/implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow diagram(s).

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow diagram(s).

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow diagram(s).

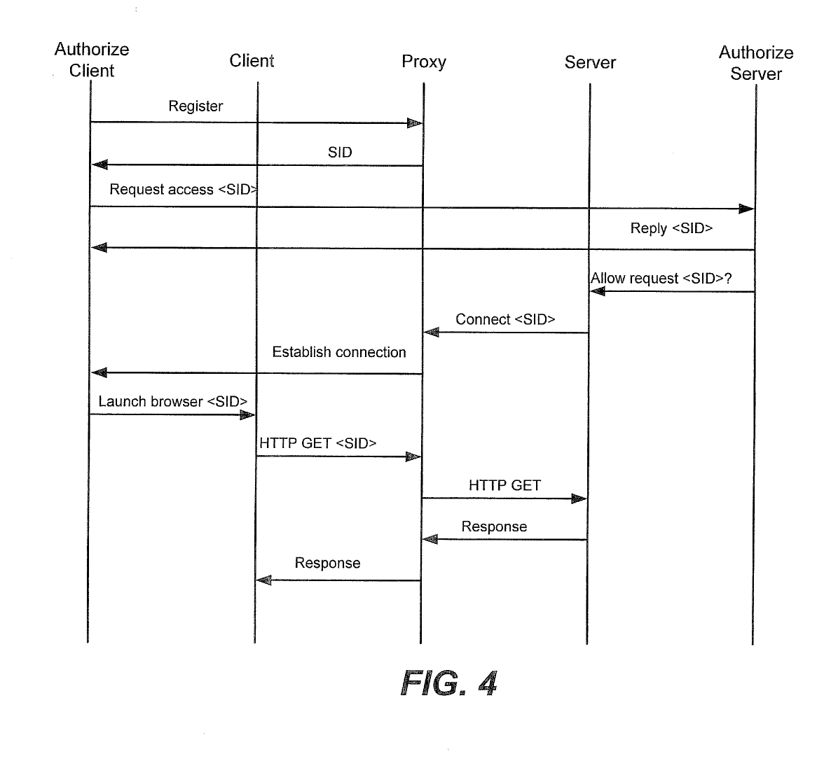

FIG. 4 is a message flow diagram that illustrates operations for providing access to files on a mobile terminal by using the phone number of a person seeking access to the files as a means of authentication in accordance with some embodiments of the present invention. For purposes of illustration, operations will be described by way of example in which a user of a mobile terminal 120 (“A party”) seeks access to files stored on mobile terminal 150 (“B party”). Operations begin with the initialization of the Web Access/Web Server module 370 on the mobile terminal 120. The Web Access/Web Server module 370 may display a list of contacts and may also allow the A party to enter a phone number manually. The A party either selects the phone number of mobile terminal 150 (B party) or enters the phone number of the B party manually.

The Web Access/Web Server module 370 then registers with the Proxy server 180 and the Proxy server 180 responds with a Session ID (SID), which may be a unique, random code that is connected to the IP number of the mobile terminal 120. The Web Access/Web Server module 370 then sends an SMS message through the SMSC 190 to the mobile terminal 150. The SMS message contains the phone number of the mobile terminal 120, the SID, and is addressed to a port to which the Web Access/Web Server module 370 running on the mobile terminal 150 subscribes. If the Web Access/Web Server module 370 is not running on the mobile terminal 150, then the Web Access/Web Server module 370 may be launched on the mobile terminal 150 responsive to receipt of the SMS message from the mobile terminal 120. In some embodiments, the Web Access/Web Server module 370 may respond with an SMS message to the mobile terminal 120 via the SMSC 190 to verify that the phone number of the mobile terminal 120 is not spoofed.

The Web Access/Web Server module 370 may then do a lookup of the number of the mobile terminal 120 and if the number is already associated with the A party in a contacts list, then the Web Access/Web Server module 370 may present the B party with the option of “allow A party to browse your phone?” If the A party is not in the contact list, then the phone number of the mobile terminal 120 may replace “A party.”

If the B party accepts the A party's request to browse the mobile terminal 150, then the Web Access/Web Server module 370 running on the mobile terminal connects to the Proxy server 180 using the SID received via the SMS message from the mobile terminal 120. If the B party declines the A party's request to browse the mobile terminal 150, then the Web Access/Web Server module 370 running on the mobile terminal 150 may connect to the Proxy server 180 to inform the A party that the request has been declined or the Web Access/Web Server module 370 running on the mobile terminal connects to the Proxy server 180 to do nothing and allow the session to terminate.

If the B party accepts the A party's request to browse the mobile terminal 150, then the Proxy server 180 notifies the mobile terminal 120 that the connection has been established to the Web server 370 running on the mobile terminal 150. The Web Access/Web Server module 370 running on the mobile terminal 120 launches the Web browser 375, which may then setup an HTTP (or HTTPS) connection to the Proxy server 180 using the SID. The Proxy server 180 may install a cookie on the Web browser 375 running on the mobile terminal 120 to ensure that the SID is sent with future requests. Because only the Web browser 375 running on Party A's phone/computer knows the SID, the Proxy server 180 can pass on the HTTP request to the Web server 370 running on the mobile terminal 150. The Web server 370 running on the mobile terminal 150 may then respond with the request information, which is provided to the Web browser 375 running on the mobile terminal 120 via the Proxy server 180. Requests from the mobile terminal 120 and responses thereto from the mobile terminal 150 may continue until the session is terminated.

In accordance with various embodiments of the present invention, a predefined folder may be setup on the mobile terminal 150 that contains files to be made accessible to authorized individuals. The particular files to be made accessible may also be identified through a setting. For example, the Web server 370 running on the mobile terminal 150 may provide access to a file folder, a picture folder, or another predefined folder. The particular folder that is made accessible may be dependent on the particular user requesting access. In some embodiments, a file named index.html, for example, may be provided that describes how the information is rendered in the Web browser 375 running on the mobile terminal 120. If an “index.html” type file is not used, then the content may be presented through a conventional file manager. Party A may click on links in the browser to access content on mobile terminal 150 and/or may click on particular files in the folder on mobile terminal 150.

In other embodiments, Party B may define “white lists” for people that may be provided access to files on mobile terminal 150 without the need for authorization from Party B. Party B may also define a “black list” for people whose requests for access to files on mobile terminal 150 will always be denied.

If Party B does not have the Web Access/Web Server application 370 installed on the mobile terminal 150, then upon receiving the SMS access request message from the mobile terminal 120, Party B may be prompted with the option to download the Web Access/Web Server application 370.

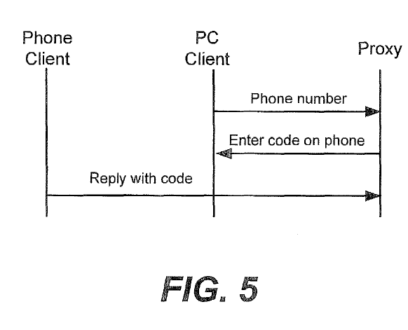

As shown in FIG. 2, Party A may wish to browse Party B's mobile terminal 150 using a computer 125, such as a Personal Computer (PC) instead of the mobile terminal 120. Operations for authenticating the computer 125, according to some embodiments of the present invention, are illustrated in FIG. 5.

Operations being with the initialization of the Web Access/Web Browser module 370 on the mobile terminal 120. Party A then uses a Web browser running on the computer 125 to access the Proxy server 180 to provide the Proxy server 180 with the phone number of the mobile terminal 120. The Proxy server 180 responds with a random code to be entered via the Web Access/Web browser module 370 on the mobile terminal 120. Party A then uses the Web Access/Web browser module 370 to send the random code to the Proxy server 180 from the mobile terminal 120. As a result, the computer 125 has now been verified to be associated with the mobile terminal 120 having a known phone number. Operations for accessing content stored on the mobile terminal 150 may then proceed as described above with respect to FIG. 4, with the exception that the computer 125 is used for access instead of the mobile terminal 120.

The message flow diagrams of FIGS. 4 and 5 illustrate the architecture, functionality, and operations of embodiments of methods, electronic devices, mobile terminals, Internet servers, and/or computer program products for providing access to files on a mobile terminal by using the phone number of a person seeking access to the files as a means of authentication. In this regard, each message and associated communication represents a module, segment, or portion of code, which comprises one or more executable instructions for implementing the specified logical function(s). It should also be noted that in other implementations, the message(s) noted in the blocks may occur out of the order noted in FIGS. 4 and 5. For example, two messages shown in succession may, in fact, be communicated substantially concurrently or the messages may sometimes be communicated in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A method of operating a first electronic device to access files on a second electronic device, comprising:
registering with a proxy server to obtain a communication session identification;
sending a request to the second electronic device to access files thereon, the request comprising the communication session identification and a phone number associated with the first electronic device; and
receiving a notification from the proxy server that a connection has been established with the second electronic device responsive to the second electronic device accepting the request.

2. The method of claim 1, further comprising:
establishing an HTTP communication session with the second electronic device via the proxy server.

3. The method of claim 1, further comprising:
displaying information for contacting the second electronic device; and
receiving input from a user indicative of a desire to contact the second electronic device;
wherein registering with the proxy server comprises registering with the proxy server responsive to the input from the user indicative of the desire to contact the second electronic device.

4. The method of claim 1, wherein sending the request to the second electronic device comprises sending the request to the second electronic device using Short Message Service (SMS).

5. The method of claim 1, further comprising:
associating a third electronic device with the first electronic device by sending a phone number associated with the first electronic device to the proxy server using the third electronic device;
receiving a code from the proxy server at the first electronic device;
sending the code received from the proxy server back to the proxy server using the first electronic device; and
establishing a communication session between the third electronic device and the second electronic device via the proxy server.

6. The method of claim 1, wherein the first and second electronic devices are mobile terminals.

7. A computer program product comprising computer-readable program code embodied on a computer-readable medium, the computer readable program code being configured to carry out the method of claim 1.

8. A method of operating a first electronic device to provide a second electronic device access to files stored thereon, comprising:
receiving a request from the second electronic device to access files stored on the first electronic device, the request comprising a communication session identification and a phone number associated with the second electronic device; and
establishing a connection with a proxy server using the session identification.

9. The method of claim 8, further comprising:
establishing an HTTP communication session with the second electronic device via the proxy server.

10. The method of claim 8, further comprising:
launching a Web server module responsive to receiving the request.

11. The method of claim 8, further comprising:
downloading a Web server module responsive to receiving the request.

12. The method of claim 8, further comprising:
sending a message to the second electronic device responsive to receiving the request to verify the phone number associated with the second electronic device.

13. The method of claim 8, further comprising:
displaying a prompt indicating that the second electronic device has requested access to the files stored on the first electronic device; and
receiving input from a user granting the request to access the files stored on the first electronic device;
wherein establishing the connection with the proxy server comprises establishing the connection with the proxy server responsive to receiving input from the user granting the request.

14. The method of claim 8, wherein the received request is a Short Message Service (SMS) message.

15. The method of claim 8, wherein the accessibility of the files on the first electronic device is based on requester identity.

16. The method of claim 15, wherein the first electronic device comprises at least one list that categorizes requesters based on file accessibility.

17. The method of claim 8, wherein the first and second electronic devices are mobile terminals.

18. A computer program product comprising computer-readable program code embodied on a computer-readable medium, the computer readable program code being configured to carry out the method of claim 8.
